(19) United States
(12) Patent Application Publication
(10) Pub. No.: US 2019/0225188 A1
(43) Pub. Date: Jul. 25, 2019

(54) BIOMETRIC ACCESS CONTROL SYSTEM FOR VEHICLE SHIFTER

(71) Applicant: Greg Nguyen, Garland, TX (US)

(72) Inventor: Greg Nguyen, Garland, TX (US)

(21) Appl. No.: 16/254,138

(22) Filed: Jan. 22, 2019

Related U.S. Application Data
(60) Provisional application No. 62/619,602, filed on Jan. 19, 2018.

(51) Int. Cl. B60R 25/25; G06F 21/32; B60R 25/00; B60R 25/24

(52) U.S. Cl. CPC B60R 25/252; B60R 25/241; B60R 25/008; G06F 21/32

(57) ABSTRACT

A biometric access control system and method which provides a biometric fingerprint lock for a vehicle shifter. The device prevents would-be drivers from shifting without proper fingerprint ID. It deters automobile thieves and helps stop unauthorized drivers, like teenagers, from taking the car. The present disclosure allows primary drivers to deactivate the unit, for example, for valet or mechanical work.

### CROSS REFERENCE TO RELATED APPLICATION

The present application is related to and claims priority to U.S. Provisional Patent Application No. 62/619,602 filed Jan. 19, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of vehicular access and more specifically relates to vehicular access using biometrics.

### 2. Description of Related Art

Currently, there are various ways to start the engine of vehicle by bypassing the ignition switch, allowing thieves to make off in a car without drivers knowing until they return back to the spot where their car was parked. Additionally, teenagers may take their parents' car without asking. Also, while children may be playing inside a vehicle, they accidentally shift it into drive. A suitable solution is desired.

U.S. Pat. No. 6,927,671 to Joseph M. DeBono relates to a biometric shifter lock control. The described biometric shifter lock control includes a biometric anti-theft gear shifter lock control for vehicles, equipment, and machinery, and other transmission actuation devices on land, water, and air, using a gear shifter. A biometric sensor scans in biometric information from a user to a central processing unit (CPU). The CPU finding a match for an authorized user deactivates a shift lock which may be built into an automatic shift vehicle or a solenoid or other switch added to a standard shift vehicle. It sounds an alarm for an unauthorized user. The control may be positioned on a gear shift knob with a flip-type protective cover. The biometrics device could be a fingerprint scanner, a retina scanner, a voice recognition system or other device programmed to operate only upon recognition of a unique biometrically measurable characteristic of one or more authorized users whose biometric data is programmed into the system.

### BRIEF SUMMARY OF THE INVENTION

In view of the foregoing disadvantages inherent in the known vehicular access using biometrics s art, the present disclosure provides a novel biometric access control system for vehicle shifter. The general purpose of the present disclosure, which will be described subsequently in greater detail, is to provide a biometric fingerprint lock for a vehicle shifter. The device prevents would-be drivers from shifting without proper fingerprint ID. It deters automobile thefts and stops unauthorized drivers, like teenagers, from taking the car. The present disclosure allows primary drivers to deactivate the unit for valet or mechanical work.

A biometric access control system is disclosed herein. The biometric access control system includes a computer which includes a memory, and is configured to store at least one fingerprint-identification profile; a biometric fingerprint reader communicably coupled to the computer, the biometric fingerprint reader configured to be affixed to the transmission shifter handle of the vehicle, and further configured to identify the authorized driver via a finger print of the authorized driver; a transmission shifter handle lock may have a locked state and an unlocked state, the transmission shifter handle lock configured to prevent the transmission shifter handle from operation when in the locked state, and further configured to enable the transmission shifter handle for operation when in the unlocked state, the transmission shifter handle lock communicably coupled to the computer and configured to enter the unlocked state when the authorized driver may be identified by the biometric fingerprint reader; and a master override configured to override the transmission shifter handle lock and maintain the transmission shifter handle lock the unlocked state when engaged and independently of the authorized driver being identified by the biometric fingerprint reader.

A method for using biometric access to a vehicle for an authorized driver is also disclosed herein. The method for providing biometric may comprise the steps of: providing the biometric access control system, as described above; scanning a first fingerprint with the biometric fingerprint reader; authenticating the authorized driver; and the transmission shifter handle lock entering an unlocked state in response to the authenticating the authorized driver.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a biometric access control system for vehicle shifter, constructed and operative according to the teachings of the present disclosure.

FIG. 1 is a partially cutaway perspective view of the biometric access control system during an ‘in-use’ condition, according to an embodiment of the disclosure.

FIG. 2 is a partially cutaway perspective view of the biometric access control system of FIG. 1, according to an embodiment of the present disclosure.

FIG. 3 is a schematic block diagram of the biometric access control system of FIG. 1, according to an embodiment of the present disclosure.

FIG. 4 is a perspective view of the biometric access control system of FIG. 1, according to another embodiment of the present disclosure

FIG. 5 is a flow diagram illustrating a method of use for the biometric access control system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electrical communications and more particularly to a biometric access control system for vehicle shifter as used to improve the biometrics.

Generally, the biometric access control system for a vehicle shifter (also known as “Digital ID Shifter”) may protect vehicles from theft or accidental engagement of the vehicles' drive shaft. This innovative product features a biometric fingerprint lock for a vehicle shifter. The shifter's lock may be configured to store up to four or more fingerprint identification profiles; however, a master override dongle may be engaged by an authorized river to allow for valet and mechanical work. Further, the master dongle may be used outside the vehicle by the authorized driver whose biometric identity corresponded to the identity stored in the vehicle's memory. The disclosure can be adapted to accommodate most makes and models currently on the market.

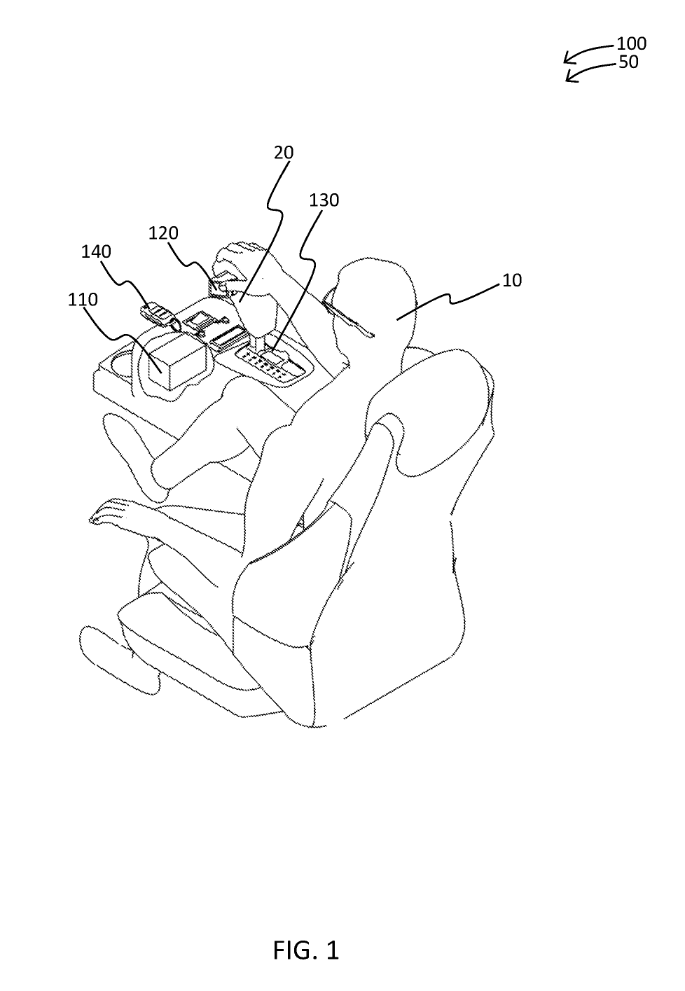

Referring now more specifically to the drawings by numerals of reference, there is shown in FIGS. 1-4, various views of a biometric access control system 100 for an authorized driver 10 of a vehicle. FIG. 1 shows a biometric access control system 100 during an ‘in-use’ condition 50, according to an embodiment of the present disclosure. As illustrated, the vehicle has a transmission shifter handle 20, and the biometric access control system 100 may include a computer 110, a biometric fingerprint reader 120, a transmission shifter handle lock 130, and a master override 140. The computer 110 may include a memory, and be configured to store at least one fingerprint-identification profile. The biometric fingerprint reader 120 may be communicably coupled to the computer, and be configured to be affixed to the transmission shifter handle 20 of the vehicle. The biometric fingerprint reader 120 may be further configured to identify the authorized driver 10 via the driver's fingerprint.

The transmission shifter handle lock 130 may have a locked or unlocked state. When in the locked state, the transmission shifter handle lock 130 prevents the transmission shifter handle 20 from operating. When an authorized driver is identified by the biometric fingerprint reader the transmission shifter handle lock 130 enters the unlocked state.

The master override 140 is configured to override the transmission shifter handle lock 130 and maintain the unlocked state when engaged, independently of an authorized driver being identified. The master override 140 may be in the form of a key fob and may have a user interface. The user interface can include at least one button, switch, or touch-screen panel. In certain embodiments the user interface may be integrated with a mobile communication device. In these embodiments, the user interface may include means of authenticating a user using a password, passphrase, personal identification number, swipe pattern, fingerprint reader, or facial recognition.

In some embodiments the computer 110 may be communicably coupled to a mobile communication device. These embodiments allow for the mobile communication device to digitally manipulate the computer 110. Some embodiments may have the computer 110 integrated in a mobile communication device. Additionally, the computer 110 may be communicably coupled to an external personal computer in some embodiments.

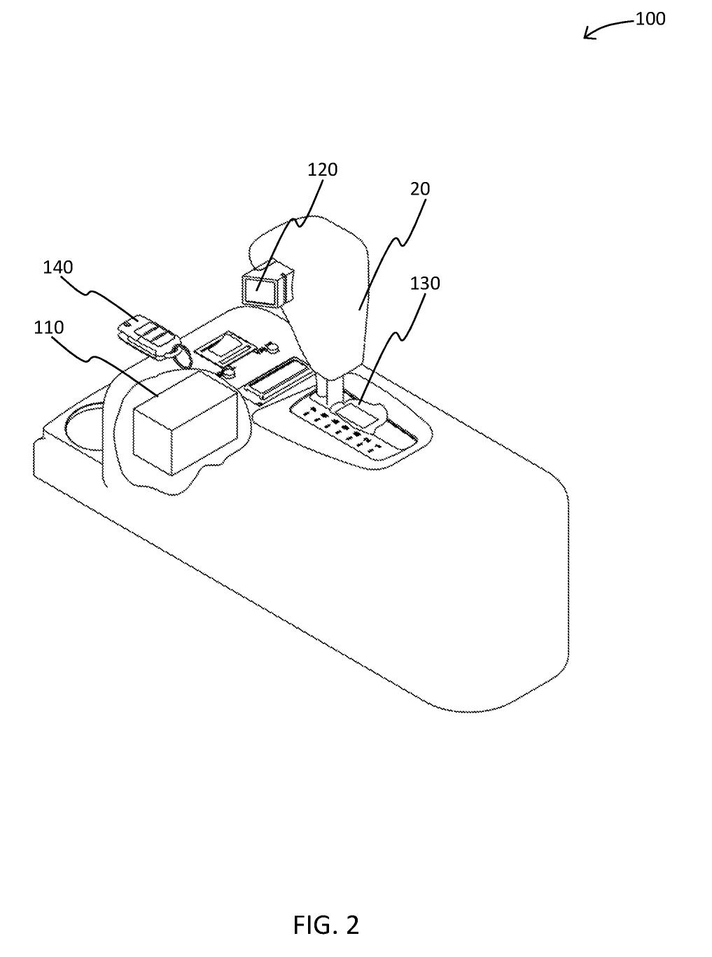

FIG. 2 is a partially cutaway perspective view of the biometric access control system 100 of FIG. 1, according to an embodiment of the present disclosure. As above, the biometric access control system 100 may include the computer 110, the biometric fingerprint reader 120, the transmission shifter handle lock 130, and the master override 140. Here the biometric fingerprint reader 120 is shown located on or proximate the transmission shifter handle 20. Advantageously, this may allow the driver 10 (FIG. 1) to conveniently use the biometric fingerprint reader 120 immediately before shifting the vehicle into drive.

According to one embodiment the transmission shifter handle lock 130 may be configured to enter the unlocked state for a specified amount of time based on the fingerprint-identification profile of the authorized driver 10. According to another embodiment the transmission shifter handle lock 130 may be further configured to enter the unlocked state during specific times, for example, the computer 110 may be preprogrammed. According to yet another embodiment, the computer 110 may be further configured to associate a fingerprint-identification profile to only have a temporary authorization for the driver 10.

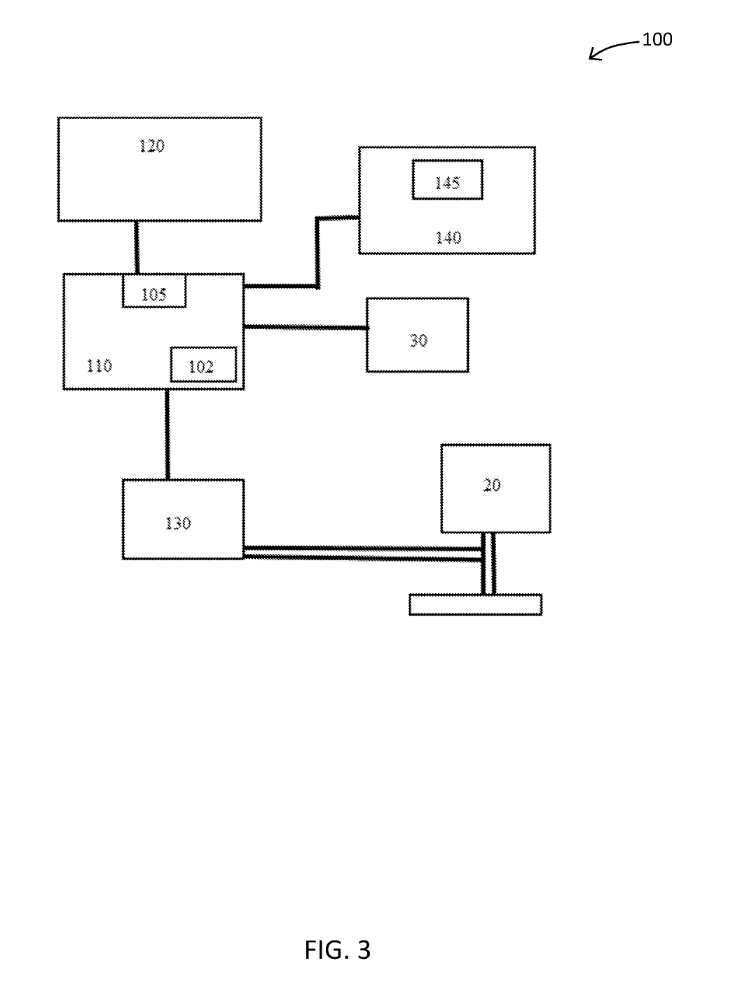

Referring now to FIG. 3, a schematic block diagram of the biometric access control system 100 of FIG. 1, according to an embodiment of the present disclosure. As above, the biometric access control system 100 may include the computer 110, the biometric fingerprint reader 120, the transmission shifter handle lock 130, and the master override 140. As shown, the biometric fingerprint reader 120 and the transmission shifter handle lock 130 may be in electrical communication with the computer 110, it is understood that this may be direct or indirect. Similarly, the transmission shifter handle lock 130 may be configured to directly or indirectly lock the transmission shifter handle 20.

As above, the computer 110 may include a memory 102 configured to store at least one fingerprint-identification profile. According to one embodiment, the computer 110 may include a receiver 105 which is configured to or otherwise able to receive a signal from at least one of the biometric fingerprint scanner 120 and the master override 140. The computer 110 may be powered by a power supply 30, for example a vehicle battery, an independent energy storage, etc. The computer 110 may be an independent unit, integrated with a vehicle computer, or otherwise configured as a shared resource.

As above, the master override 140 may include a user interface 145. According to one embodiment, the user interface 145 may be integrated into or with a mobile communication device. In operation, when the computer 110 has received the appropriate authorization signal from either the biometric fingerprint scanner 120 or the master override 140, the computer will send a signal to the transmission shifter handle lock 130 to enter the unlocked state and allow the authorized driver 10 (FIG. 1) to take the transmission out of park.

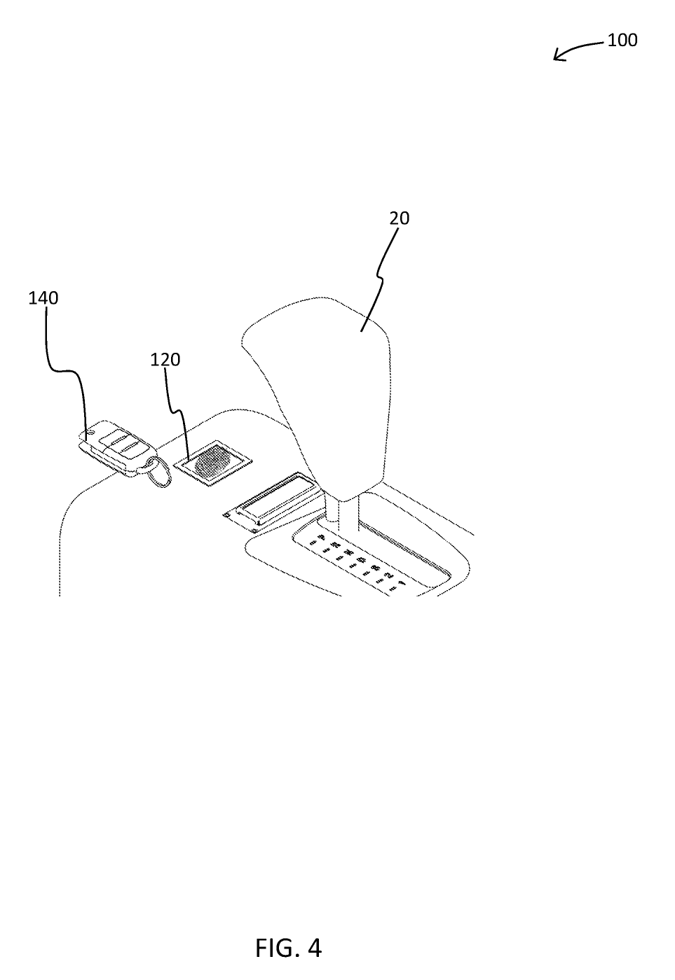

FIG. 4 shows a perspective view of the biometric access control system 100 of FIG. 1, according to another embodiment of the present disclosure. As above, the biometric access control system 100 may include the computer 110 (FIG. 1), the biometric fingerprint reader 120, the transmission shifter handle lock 130 (FIG. 1), and the master override 140. As shown here, the biometric fingerprint reader 120 may be affixed or otherwise coupled to other interior surfaces of a vehicle.

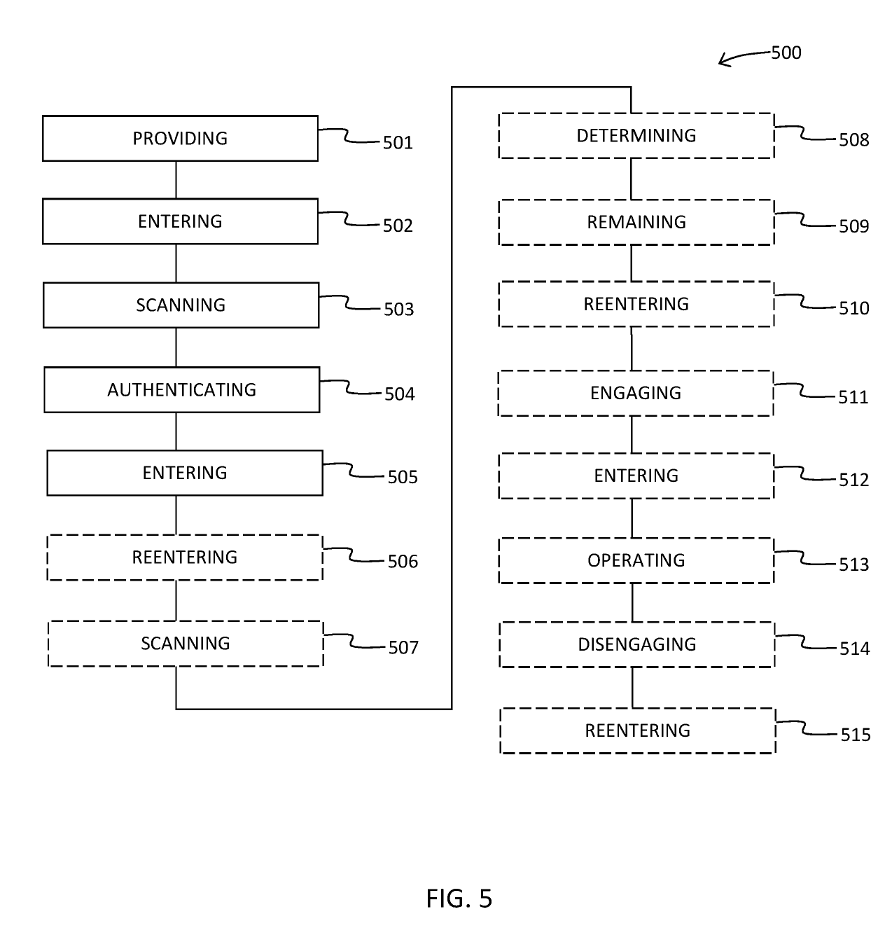

Referring now to FIG. 5 showing a flow diagram illustrating a method 500 for providing biometric access to a vehicle for an authorized driver, according to an embodiment of the present disclosure. As illustrated, the method 500 for providing biometric access to the vehicle for the authorized driver may include the first step of: providing 501 a biometric access control system including a computer including a memory, and configured to store at least one fingerprint-identification profile; a biometric fingerprint reader communicably coupled to the computer, the biometric fingerprint reader configured to be affixed to the transmission shifter handle of the vehicle, and further configured to identify the authorized driver via a finger print of the authorized driver; a transmission shifter handle lock may have a locked state and an unlocked state, the transmission shifter handle lock configured to prevent the transmission shifter handle 20 from operation when in the locked state, and further configured to enable the transmission shifter handle for operation when in the unlocked state, the transmission shifter handle lock communicably coupled to the computer and configured to enter the unlocked state when the authorized driver may be identified by the biometric fingerprint reader; and a master override configured to override the transmission shifter handle lock and maintain the transmission shifter handle lock the unlocked state when engaged and independently of the authorized driver being identified by the biometric fingerprint reader; the transmission shifter handle lock. The method 500 may include the additional steps of: entering 502 a locked state; scanning 503 a first fingerprint with the biometric fingerprint reader; authenticating 504 the authorized driver; and the transmission shifter handle lock entering 505 an unlocked state in response to the authenticating the authorized driver.

According to one embodiment, the method 500 may further include the steps of: the transmission shifter handle lock reentering 506 the locked state; scanning 507 a second fingerprint with the biometric fingerprint reader; determining 508 an unauthorized driver; and the transmission shifter handle lock remaining 509 in the locked state in response to the determining the unauthorized driver. According to another embodiment, the method 500 may further include the steps of: the transmission shifter handle lock reentering 510 the locked state; engaging 511 the master override; the transmission shifter handle lock entering 512 an unlocked state in response to the engaging the master override; operating 513 the transmission shifter handle lock with the master override engaged; disengaging 514 the master override; and the transmission shifter handle lock reentering 515 the locked state in response to the disengaging the master override.

It should be noted that steps 506-515 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the biometric access control system 100 (e.g., different step orders within above-mentioned list, elimination or addition of certain steps, including or excluding certain maintenance steps, etc.), are taught herein.

The embodiments of the disclosure described herein are exemplary. Numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A biometric access control system for an authorized driver of a vehicle, said vehicle having a transmission shifter handle, the system comprising:
a computer including a memory, and configured to store at least one fingerprint-identification profile;
a biometric fingerprint reader communicably coupled to the computer, the biometric fingerprint reader configured to be affixed to the transmission shifter handle of the vehicle, and further configured to identify the authorized driver via a finger print of the authorized driver;
a transmission shifter handle lock having a locked state and an unlocked state, the transmission shifter handle lock configured to prevent the transmission shifter handle from operation when in the locked state, and further configured to enable the transmission shifter handle for operation when in the unlocked state, the transmission shifter handle lock communicably coupled to the computer and configured to enter the unlocked state when the authorized driver is identified by the biometric fingerprint reader; and
a master override configured to override the transmission shifter handle lock and maintain the transmission shifter handle lock the unlocked state when engaged and independently of the authorized driver being identified by the biometric fingerprint reader.

2. The biometric access control system of claim 1, wherein said master override includes a user interface operable by a user to manually operate the master override.

3. The biometric access control system of claim 2, wherein the user interface includes at least one button.

4. The biometric access control system of claim 2, wherein the user interface includes at least one switch.

5. The biometric access control system of claim 2, wherein the user interface includes a key fob.

6. The biometric access control system of claim 2, wherein the user interface includes a touch-screen panel.

7. The biometric access control system of claim 2, wherein the user interface is integrated with a mobile communication device.

8. The biometric access control system of claim 7, wherein the user interface includes a means of authenticating a user selected from a group containing: a password, a passphrase, a personal identification number, a swipe pattern, fingerprint reader, and facial recognition.

9. The biometric access control system of claim 1, wherein the transmission shifter handle lock is further configured to enter the unlocked state for a specified amount of time based on the fingerprint-identification profile of the authorized driver.

10. The biometric access control system of claim 1, wherein the transmission shifter handle lock is further configured to enter the unlocked state during specific times.

11. The biometric access control system of claim 1, wherein the computer is further configured to set the at least one fingerprint-identification profile as only temporarily authorizing the authorized driver.

12. The biometric access control system of claim 1, wherein the biometric fingerprint reader is further configured to be affixed to an interior surface other than the transmission shifter handle of the vehicle.

13. The biometric access control system of claim 1, wherein the computer is communicably coupled to a mobile communication device.

14. The biometric access control system of claim 13, wherein the mobile communication device is configured to digitally manipulate the computer.

15. The biometric access control system of claim 1, wherein the computer is communicably coupled to an external personal computer.

16. The biometric access control system of claim 1, wherein the computer is integrated in a mobile communication device.

17. A biometric access control system for an authorized driver of a vehicle, said vehicle having a transmission shifter handle, the biometric access control system comprising:
a computer including a memory, and configured to store at least one fingerprint-identification profile;
a biometric fingerprint reader communicably coupled to the computer, the biometric fingerprint reader configured to be affixed to the transmission shifter handle of the vehicle, and further configured to identify the authorized driver via a finger print of the authorized driver;
a transmission shifter handle lock having a locked state and an unlocked state, the transmission shifter handle lock configured to prevent the transmission shifter handle from operation when in the locked state, and further configured to enable the transmission shifter handle for operation when in the unlocked state, the transmission shifter handle lock communicably coupled to the computer and configured to enter the unlocked state when the authorized driver is identified by the biometric fingerprint reader; and
a master override configured to override the transmission shifter handle lock and maintain the transmission shifter handle lock the unlocked state when engaged and independently of the authorized driver being identified by the biometric fingerprint reader; and
wherein said master override includes a user interface operable by a user to manually operate the master override;
wherein the user interface includes a key fob;
wherein the transmission shifter handle lock is further configured to enter the unlocked state a specified amount of time based on the fingerprint-identification profile of the authorized driver;
wherein the transmission shifter handle lock is further configured to enter the unlocked state during specific times;
wherein the computer is further configured to set the at least one fingerprint-identification profile as only temporarily authorizing the authorized driver;
wherein the computer is communicably coupled to a mobile communication device; and
wherein the mobile communication device is configured to digitally manipulate the computer.

18. A method for providing biometric access to a vehicle for an authorized driver, said vehicle having a transmission shifter handle, the method comprising the steps of:
providing a biometric access control system including
a computer including a memory, and configured to store at least one fingerprint-identification profile;
a biometric fingerprint reader communicably coupled to the computer, the biometric fingerprint reader configured to be affixed to the transmission shifter handle of the vehicle, and further configured to identify the authorized driver via a finger print of the authorized driver;
a transmission shifter handle lock having a locked state and an unlocked state, the transmission shifter handle lock configured to prevent the transmission shifter handle from operation when in the locked state, and further configured to enable the transmission shifter handle for operation when in the unlocked state, the transmission shifter handle lock communicably coupled to the computer and configured to enter the unlocked state when the authorized driver is identified by the biometric fingerprint reader; and
a master override configured to override the transmission shifter handle lock and maintain the transmission shifter handle lock the unlocked state when engaged and independently of the authorized driver being identified by the biometric fingerprint reader;
the transmission shifter handle lock entering a locked state;
scanning a first fingerprint with the biometric fingerprint reader;
authenticating the authorized driver; and
the transmission shifter handle lock entering an unlocked state in response to the authenticating the authorized driver.

19. The method of claim 18, further comprising the steps of:
the transmission shifter handle lock reentering the locked state;
scanning a second fingerprint with the biometric fingerprint reader;
determining an unauthorized driver; and
the transmission shifter handle lock remaining in the locked state in response to the determining the unauthorized driver.

20. The method of claim 18, further comprising the steps of:
the transmission shifter handle lock reentering the locked state;
engaging the master override;
the transmission shifter handle lock entering an unlocked state in response to the engaging the master override;
operating the transmission shifter handle lock with the master override engaged;
disengaging the master override; and
the transmission shifter handle lock reentering the locked state in response to the disengaging the master override.
